(19) United States
(12) Patent Application Publication
(10) Pub. No.: US 2013/0107289 A1
(43) Pub. Date: May 2, 2013

(54) RASTERIZATION OF PRINTING DATA

(71) Applicants: Lukasz Konrad Brodzinski, Redmond, WA (US); Zabir Hoque, Seattle, WA (US); Anthony Martin Presley, Seattle, WA (US); Kanwal VedBrat, Bellevue, WA (US); Herman Widjaja, Sammamish, WA (US); Ahmet Gurcan, Mercer Island, WA (US)

(72) Inventors: Lukasz Konrad Brodzinski, Redmond, WA (US); Zabir Hoque, Seattle, WA (US); Anthony Martin Presley, Seattle, WA (US); Kanwal VedBrat, Bellevue, WA (US); Herman Widjaja, Sammamish, WA (US); Ahmet Gurcan, Mercer Island, WA (US)

(73) Assignee: Microsoft Corporation, Redmond, WA (US)

(21) Appl. No.: 13/284,834

(22) Filed: Oct. 28, 2011

(51) Int. Cl. G06K 15/02

(52) U.S. Cl. 358/1.9

(57) ABSTRACT

Techniques for determining how to perform a rasterization of printing data. A rasterization facility may receive from a printer driver a request to rasterize printing data in a page description language (PDL) format. The rasterization facility may select a processing unit on which to rasterize the printing data, which may include determining whether to invoke a GPU or a CPU to perform the rasterization. When the GPU is selected, the CPU and GPU may be operated concurrently to perform rasterization. For example, while the GPU is rasterizing a first portion of the printing data, the CPU may determine a next portion to be rasterized, such that the next portion may be made available to the GPU when the GPU is ready to rasterize another portion. The rasterization facility may also convert printing elements of the printing data to a target color space.

### BACKGROUND

A computing device can provide data to be printed to a printer in different formats. Among these formats are printing data arranged in a Page Description Language (PDL) and rasterized printing data.

Printing data arranged in a PDL format may identify and describe each printing element of the page to be produced, such as blocks of text and binary images and their locations in the page. Multiple different PDLs exist, including the Extensible Markup Language (XML) Paper Specification (XPS) and OpenXPS languages. In XPS and OpenXPS, each printing element of the page may be identified using one or more XML nodes that may, in some cases, reference data to be used in printing the printing element, such as font data, image data, color profile data, and other data.

Rasterized printing data indicates the contents of the page to be produced by the printer in a raster format. Unlike the PDL format, which describes the elements of the page, the raster format includes information regarding an array of points of the page, such as locations in the page at which the printer is to deposit toner, ink, or some other substance to create content of the page.

Some printers are configured to accept printing data from a computing device only in a raster format. A corresponding printer driver of the computing device may therefore be responsible for ensuring that printing data is in the raster format for the printer before the printing data is communicated to the printer. When such a printer driver receives printing data arranged in a PDL format, the printer driver “rasterizes” the printing data by creating a rasterized version of the printing data in the PDL format. The printer driver may then provide the rasterized printing data to the printer.

Rasterization of printing data arranged in a PDL was traditionally performed by a central processing unit (CPU) of a computing device. While graphics processing units (GPUs) of computing devices are specially adapted to perform operations related to graphics, including rasterization, GPUs were traditionally only available for operations related to electronic display of computer graphics. GPUs could not be programmed or operated to perform generic processing operations for data not related to electronic displays. When the ShaderModel 2.0 industry standard and programmable GPUs became available, however, techniques were developed for using GPUs to perform rasterization of printing data. Further, with the introduction of the ShaderModel 3.0 industry standard, rasterization of color printing data became available.

### SUMMARY

Rasterizing printing data using a GPU can be desirable, as the GPU may be adapted to perform quickly and efficiently operations related to rasterization. However, Applicants have recognized and appreciated that, in some cases, using the GPU to perform rasterization may be disadvantageous. For example, in some computing devices and for some requests to rasterize printing data, performing a rasterization process on a GPU may take longer than performing the rasterization on the CPU or operating both the CPU and GPU to perform parts of a rasterization process. Applicants have recognized and appreciated that, in these cases, performing a rasterization process at least partially on the CPU may be more desirable, despite that the GPU may be adapted to perform rasterization operations.

Applicants have therefore recognized and appreciated the desirability of a rasterization facility for execution on a computing device that interacts with printer drivers of the computing device and determines how to rasterize printing data to be provided to a printer. Such a rasterization facility may determine whether to perform a rasterization of printing data on a CPU or on a GPU of the computing device and how to operate the CPU to participate in the rasterization. Based on that determination, the rasterization facility may selectively invoke one or both of the CPU and GPU to rasterize printing data.

Described herein are various systems and techniques for determining how to perform a rasterization of printing data. In some embodiments, a graphics library of a computing device may include a rasterization facility that is configured to receive printing data from a printer driver of the computing device, where the printing data may be arranged according to a page description language (PDL). The rasterization facility may receive the printing data along with a request to rasterize the printing data. In response, the rasterization facility may determine how to rasterize the printing data. In embodiments, determining how to rasterize the printing data may include selecting a processing unit on which to rasterize the printing data, which may include determining whether to operate the GPU perform the rasterization. The selection of a processing unit may be based on any suitable criteria, examples of which are discussed below.

In some embodiments, when the rasterization facility selects the GPU to rasterize the printing data, the CPU and GPU may be operated together to perform operations related to the rasterization. For example, while the GPU is rasterizing a portion of the printing data, the CPU may review the printing data to determine a next portion to be rasterized, such that the next portion may be made available to the GPU when the GPU is ready to accept another portion for rasterization. Additionally, in some embodiments, the CPU may be configured to retrieve the rasterized printing data from the GPU while the GPU is rasterizing a next portion of the printing data.

Further, in some embodiments, when a rasterization facility receives a request to rasterize printing data, the request may specify a target color space in which the printing data will be printed. Prior to rasterizing the printing data, the facility may review elements of the printing data to determine an original color space of the elements and, if the original color space of an element does not match the target color space, the facility may convert the element to the target color space.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary a computing device with which some embodiments may operate;

FIG. 2 is a flowchart of an exemplary process that may be performed to rasterize printing data;

FIG. 3 is a flowchart of an exemplary process for determining whether to rasterize printing data using a graphics processing unit;

FIG. 4 is a flowchart of an exemplary process for dividing printing data into multiple portions to be rasterized using a graphics processing unit;

FIG. 5 is a flowchart of an exemplary process for operating a central processing unit and a graphics processing unit concurrently to perform a rasterization process;

FIG. 6 is a timing diagram of exemplary operations that may be carried out by a central processing unit and a graphics processing unit operating concurrently to perform a rasterization process;

FIG. 7 is a flowchart of an exemplary process for converting printing elements to a target color space; and

FIG. 8 is a block diagram of an exemplary computing device with which some embodiments may operate.

### DETAILED DESCRIPTION

Applicants have recognized and appreciated that while GPUs may be specially adapted for rasterization operations, rasterizing printing data on a GPU may not be desirable in all cases. In some cases, rather, a general purpose central processing unit (CPU) may rasterize printing data more quickly or efficiently, despite that the CPU is not specially adapted in the manner of the GPU. Applicants have also recognized and appreciated that a division of operations between the CPU and GPU may result in speed or efficiency gains for rasterization, but that inefficient interactions between the GPU and CPU or an inefficient division of operations between the GPU and CPU may prevent the rasterization process from realizing such benefits. Applicants have recognized and appreciated, therefore, the advantages offered by techniques that determine, when a request to rasterize printing data is received, how to rasterize the printing data, including by selecting a CPU or a GPU on which to perform the rasterization.

Described herein are techniques for rasterizing printing data that include selecting a CPU or a GPU to perform the rasterization. The selection between the CPU and GPU may be based on any suitable criteria, examples of which are described in detail below.

In some embodiments, a rasterization facility of a graphics library is configured to receive printing data arranged in a PDL and a request to rasterize the printing data. The rasterization facility may receive the printing data and request from a printer driver installed on the computing device on which the rasterization facility executes and that is associated with a printer. The rasterization facility may determine how to rasterize the printing data, including evaluating the criteria mentioned above and selecting whether to perform the rasterization on the CPU and GPU.

In some embodiments, a rasterization facility may also determining whether and how to operate a CPU and a GPU concurrently to perform the rasterization. Applicants have recognized and appreciated that transferring data between a CPU and a GPU can be relatively slow and that this may slow the entire rasterization process, particularly when multiple pieces of data must be exchanged between the CPU and GPU. In some embodiments, the rasterization facility may expedite the rasterization process through operating the CPU to perform operations relating to the rasterization process while the GPU performs other operations of the rasterization. For example, the rasterization facility may operate the CPU to determine drawing commands to be provided to the GPU for rasterizing a next portion of printing data while the GPU executes drawing commands to rasterize a first portion. Operating the processing units concurrently to perform different parts of a rasterization process may increase the efficiency and speed of the overall process.

Further, in some embodiments, a rasterization facility may receive, with the request to rasterize the printing data, an indication of a target color space in which the printing data is to be rasterized. The rasterization facility may then determine whether any printing elements of the printing data are arranged in a different color space. If an original color space of a printing element differs from the target color space, in some embodiments the rasterization facility may convert the printing element to the target color space before being rasterized.

Examples of ways in which these techniques may be implemented are described in detail below. It should be appreciated, however, that embodiments are not limited to operating according to these techniques and that the principles described herein may be implemented in any suitable manner.

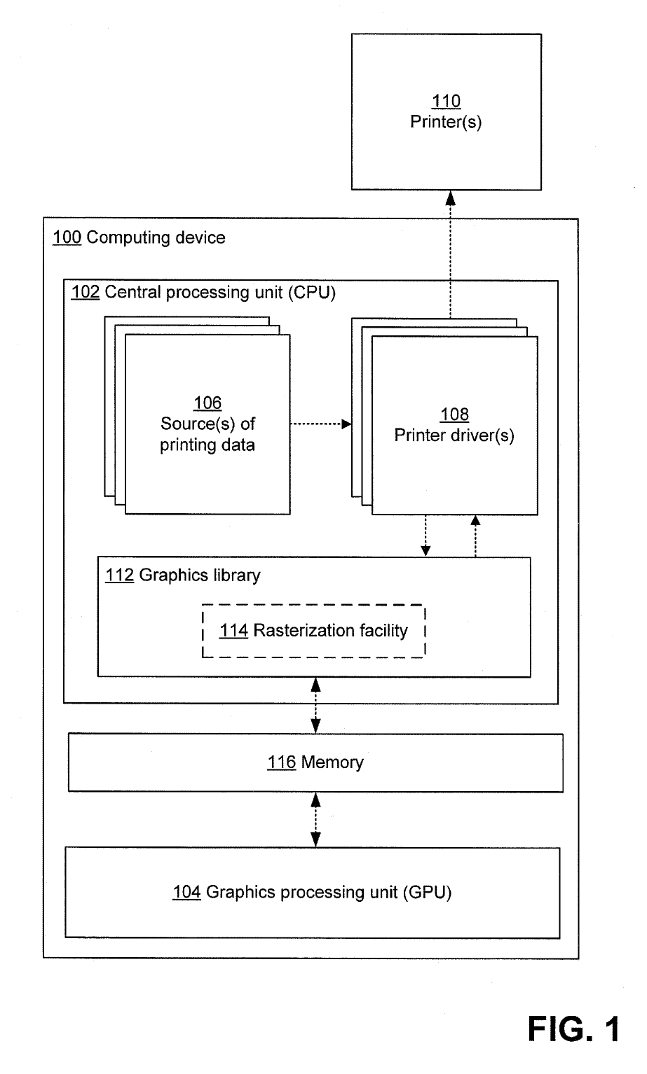

FIG. 1 is a block diagram of an exemplary computing device with which some embodiments may operate. The computing device 100 may be any suitable computing device, including a laptop or desktop personal computer or tablet computer, as embodiments are not limited in this respect. As shown in FIG. 1, the computing device 100 includes a central processing unit (CPU) 102 and a graphics processing unit (GPU) 104. The CPU 102 may be any suitable general-purpose CPU, including one with multiple processing cores, that may be operated with computer-executable instructions to carry out various tasks. The GPU 104 may be any suitable co-processor to the CPU 102 that may communicate with the CPU 102 to perform processing tasks for the computing device 100. The GPU 104 may be specially adapted to perform graphics operations, such as by having a hardware or software arrangement that enables efficient performance of graphics operations. Such adaptation may permit the GPU 104 to perform rasterization operations efficiently.

The CPU 102 and the GPU 104 may be operated to rasterize printing data to be provided to a printer. Such printing data may be generated on the computing device 100 or received at the computing device 100 from a remote location by one or more sources of printing data 106. The CPU 102 may be configured to execute instructions for the sources 106 such that printing data is made available on the computing device 100. Such sources of printing data 106 may include application programs like word processing programs, image editing programs, and web browsers, system software like operating systems and security facilities, and any other software facility that generates data suitable for printing. Additionally or alternatively, such sources of printing data 106 may include processes that receive printing data generated on another computing device, such as printing data generated on a remote computing device and transmitted via a communication network to the computing device 100 such that the transmitted printing data can be printed.

Printing data, however or wherever generated, can be provided from the sources of printing data 106 to one or more printer drivers 108 of the computing device 100. The CPU 102 may be configured to execute instructions for the printer drivers 108. Each of the printer drivers 108 may be related to a printer to which the computing device 100 is configured to send printing data for printing. Each printer driver 108 may be configured to perform operations to prepare printing data for the printer 110 to which the driver is related. The printer(s) 110 to which the drivers relate are devices that provide physical output of data managed by the computing device 100, such as by creating a representation of that data on paper. To create the physical output, the printer(s) 110 may deposit toner, ink, or another substance at locations on a paper according to the printing data. The printing data may be provided to the printer(s) 110 in any suitable way, including via one or more interfaces of the computing device 100. Where a printer 110 is remote from the computing device 100, such as attached to a network or to another computing device on the network, the printing data may be provided over such a network and over a network interface of the computing device 100. Where a printer 100 is a locally-available peripheral of the computing device 100, the printing data may be transmitted to the printer 110 via a wired and/or wireless peripheral interface of the computing device 100, including a Universal Serial Bus (USB) interface and a BLUETOOTH® wireless interface.

Among the operations a driver 108 performs for preparing printing data may be operations to ensure that the printing data is in a correct format for the printer. For example, in some embodiments where a related printer 110 is adapted to receive rasterized printing data and a driver 108 receives from a source 106 printing data arranged in a PDL, the driver 108 is responsible for rasterizing the printing data. To rasterize printing data, a printer driver may communicate with a graphics library 112 of the computing device 100 for which the CPU 102 is configured to execute instructions. The graphics library 112 may be configured to perform graphics-related operations on the computing device 100, including preparing data for electronic display such as via a computer monitor. The graphics library 112 may also include a rasterization facility 114 to perform rasterization of printing data.

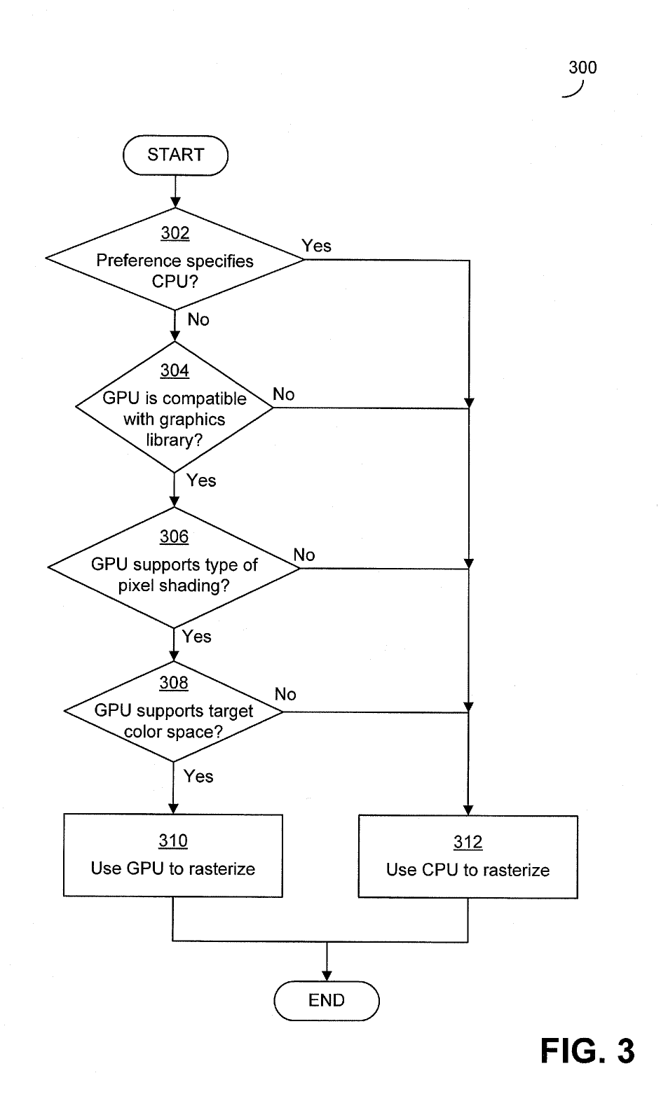

To rasterize printing data, a printer driver 108 may communicate printing data received from a source of printing data 106 to the rasterization facility 114. The communication may be performed in any suitable manner, including via one or more Application Programming Interface (API) function calls of the graphics library 112. Upon receiving the printing data from the printer driver 108, the rasterization facility 114 may determine how to rasterize the printing data. As part of determining how to rasterize the printing data, the rasterization facility 114 may select one or both of the CPU 102 and GPU 104 to perform the rasterization. The selection between the processing units may be based on an evaluation of any suitable criteria, examples of which are described below in connection with FIG. 3.

When the rasterization facility 114 selects the CPU 102 to perform rasterization of the printing data received from the printer driver 108, the rasterization facility 114 may operate the CPU 102 to perform the rasterization. The CPU 102 may rasterize PDL data in any suitable manner, including using known techniques, as embodiments are not limited in this respect.

When the rasterization facility 114 selects the GPU 104 to perform rasterization of the printing data, the rasterization facility 114 converts the PDL data of the printing data to a series of drawing commands that are executable by the GPU 104. The rasterization facility 114 may convert the PDL data to drawing commands in any suitable manner, including using known techniques, as embodiments are not limited in this respect. After creating the drawing commands, the rasterization facility 114 conveys the drawing commands to the GPU 104 and configures the GPU 104 to execute the drawing commands. Such providing and configuring may, in some embodiments, involve writing the drawing commands to a memory 116 of the computing device 100. The memory 116 may be any suitable memory of the computing device 100, including a video memory of the computing device that is directly accessible by the GPU 104. Once the GPU 104 is configured with the drawing commands, the GPU 104 executes the drawing commands to rasterize the printing data and stores the resulting rasterized printing data in the memory 116. The rasterized printing data may be stored, for example, in a staging buffer of the memory 116 that provides a mechanism for the CPU 102 and GPU 104 to exchange data. When the GPU 104 completes rasterization of the printing data, the rasterization facility 114 retrieves the rasterized printing data and provides the rasterized printing data to the printer driver 108. The printer driver 108 may then process the rasterized printing data in any suitable manner and provide the printing data to the printer 110 for printing.

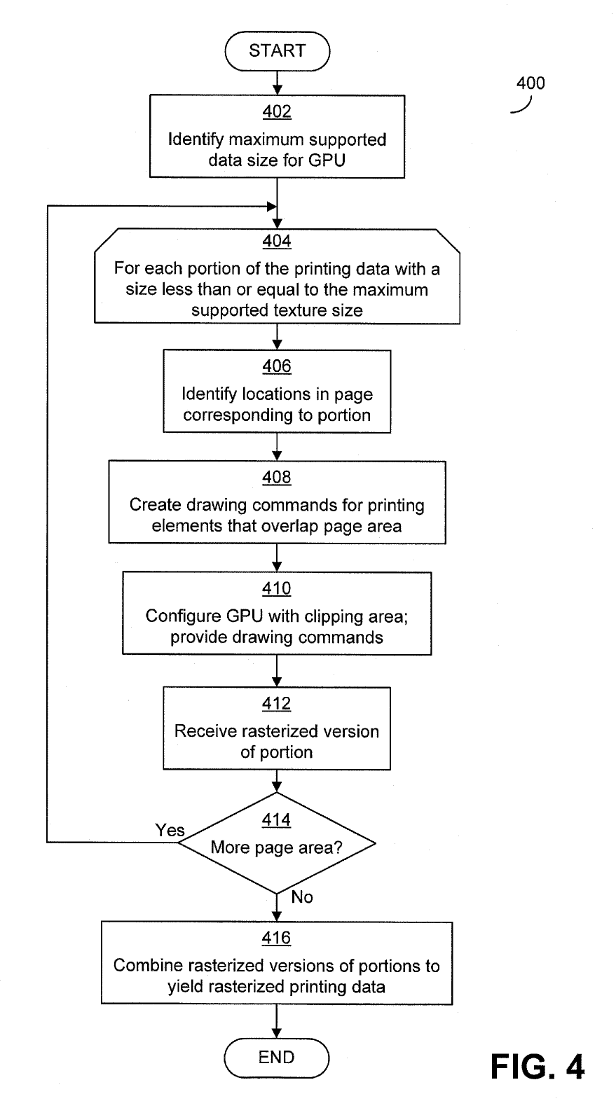

A GPU 104 may have a limit on the amount of data that can be processed by the GPU 104 at a particular time. This maximum data size may impose a limit on the rasterization process when the amount of printing data to be rasterized is larger than the maximum data size. When the amount of printing data exceeds the maximum data size of the GPU 104, the printing data may be communicated to the GPU 104 in multiple portions. Embodiments that rasterize printing data in multiple portions may use any suitable techniques for dividing the printing data into portions, rasterizing the portions, and combining the portions, including known techniques and techniques described below in connection with FIG. 4.

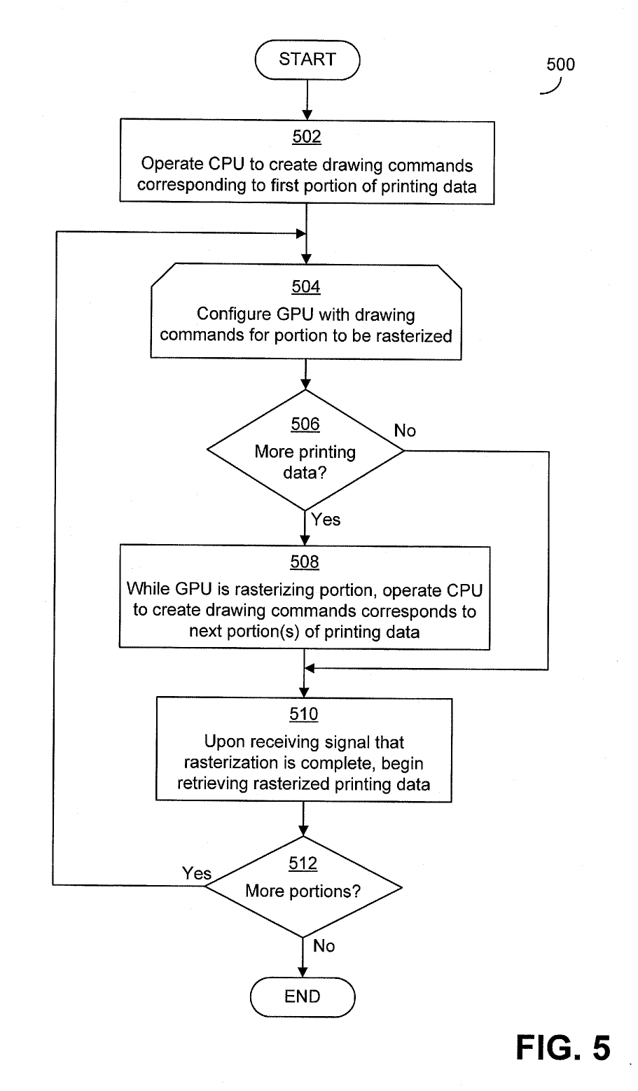

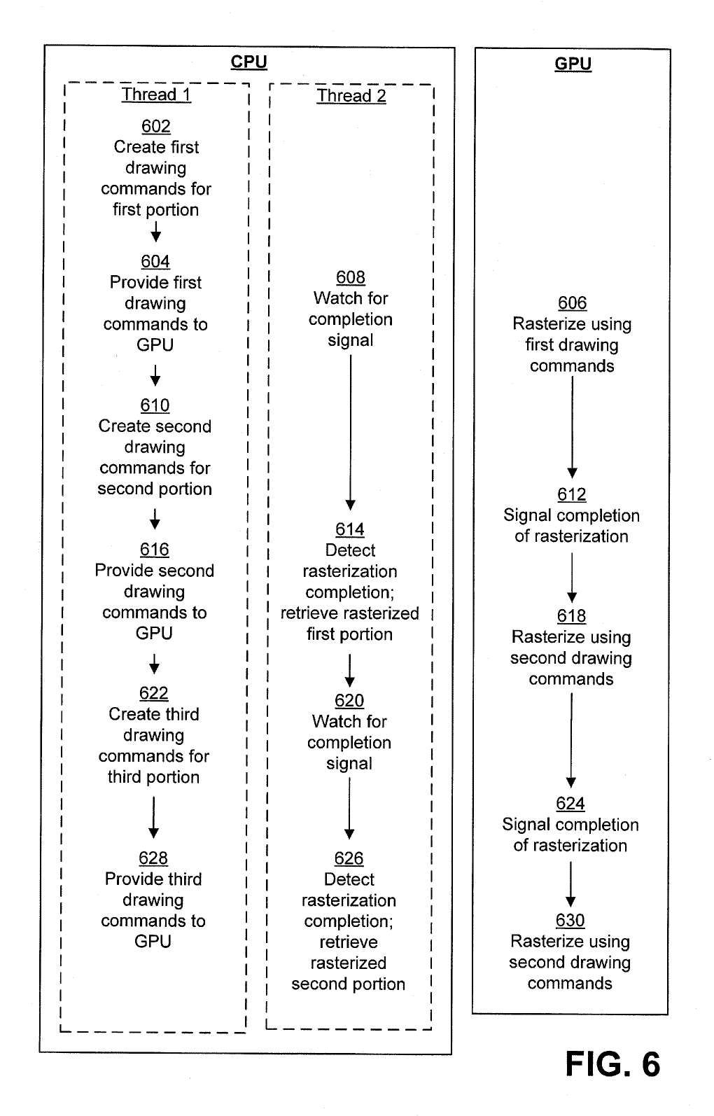

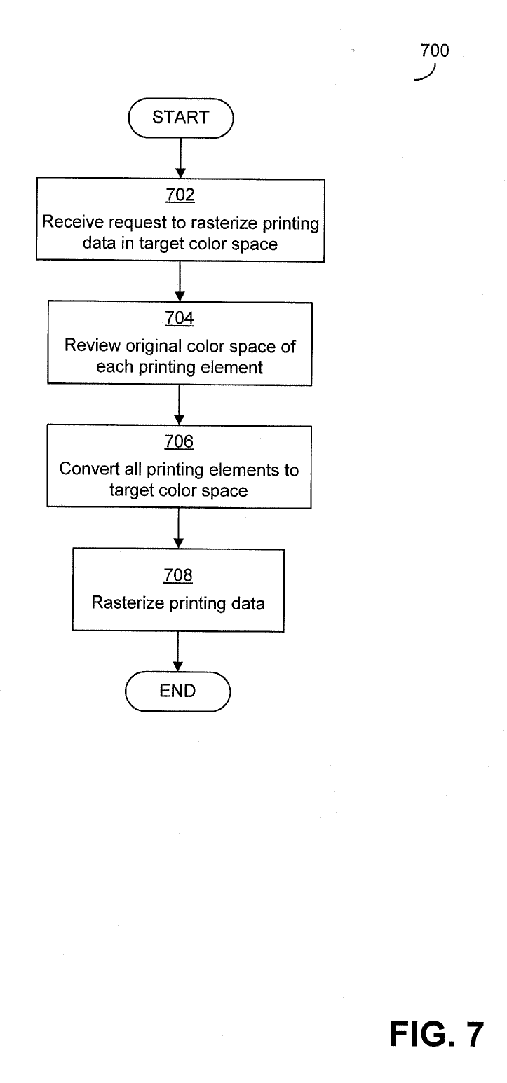

Also, in some embodiments, as described below in connection with FIGS. 5-6, the rasterization facility 114 may take various actions to operate the CPU and GPU concurrently to perform parts of the rasterization process when the GPU is selected to perform rasterization. The rasterization facility 114 may also, as discussed below in connection with FIG. 7, in some embodiments perform various operations related to a color space in which the printing data is to be rasterized.

It should be appreciated that the computing device 100 of FIG. 1 is merely illustrative of the types of computing devices with which embodiments may operate and that embodiments are not limited to operating with the computing device or environment of FIG. 1. Other computing devices may be used. For example, while in FIG. 1 the computing device included only one CPU and one GPU, in some embodiments a computing device may have multiple CPUs and/or multiple GPUs. A rasterization facility may make use of multiple CPUs/GPUs in any suitable manner, including by allocating processing responsibility for rasterization to multiple CPUs/GPUs. Further, it should be appreciated that while in FIG. 1 the rasterization facility was described as being a part of the graphics library 112, in some embodiments a rasterization facility that carries out techniques described herein may be implemented apart from a graphics library and may be used without a graphics library.

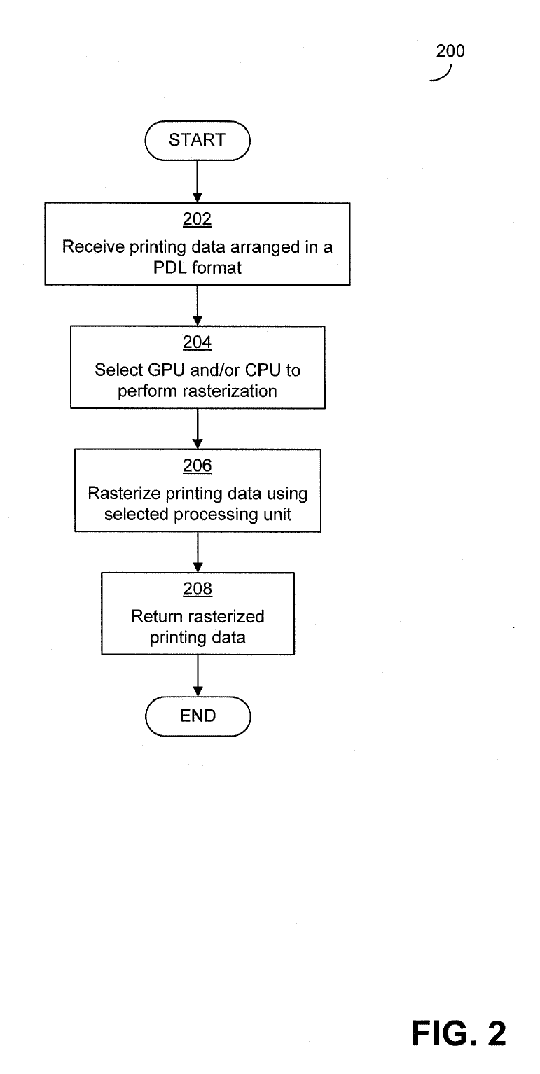

A rasterization facility, however implemented, can carry out techniques described herein in any suitable manner. FIG. 2 illustrates a flowchart of an exemplary process for performing a rasterization of printing data.

The process 200 of FIG. 2 begins in block 202, in which a rasterization facility receives printing data arranged in a PDL format. The printing data may be received from any suitable entity, including from a printer driver related to the printer to which the printing data is to be sent for printing. The PDL printing data may be received in block 202 along with or in the form of a request to rasterize the PDL printing data. The request to rasterize the PDL printing data may include any suitable information about what data to rasterize or how to rasterize the data. For example, the request may include an indication of which part(s) of the printing data are to be rasterized, when the entity requesting the rasterization desires that only a part be rasterized. This may be the case where only a part of the printing data is to be printed by the printer. As another example, the request may include an indication of a desired resolution of the rasterization. The desired resolution may be based on the printing resolution of the printer to which the rasterized printing data is to be provided, which may be expressed in the form of a dots-per-inch (DPI) measure. The resolution of the printer may be used such that, when the printing data is rasterized, the result includes at least one data value for each point of the page (“dot”) at which the printer is to deposit ink, toner, or another substance to create the content of the page.

In block 204, the rasterization facility selects a processing unit on which the printing data is to be rasterized. The selection may be made by evaluating one or more criteria upon receipt of the printing data or by reviewing results of a prior evaluation of one or more criteria or both, by reviewing both presently-evaluated and previously-evaluated criteria. These criteria may be any suitable criteria, as embodiments are not limited in this respect. Examples of criteria include criteria related to the printing data, the processing units, or other hardware/software capabilities of the computing device on which the rasterization is to be performed, as well as preferences regarding rasterization. In general, such criteria may aid in determining which processing unit (a CPU or a GPU) would be faster or more efficient in performing the rasterization of the printing data, though the criteria may relate to any suitable type of determination. Examples of criteria that may be evaluated are discussed below in connection with FIG. 3.

Based on the results of the evaluations, in block 204 the rasterization facility may select the CPU or the GPU of the computing device on which to rasterize the printing data. In block 206, the selected processing unit is invoked and operated to perform rasterization of the printing data. The rasterization may be performed by the selected processing unit in any suitable manner, including according to techniques described herein and according to known techniques. To perform rasterization on a GPU, for example, known techniques for creating drawing commands corresponding to the printing elements identified and described by the PDL of the printing data received in block 202 may be used and the drawing commands may then be executed by the GPU to create rasterized printing data.

Once the rasterization is performed by the selected processing unit, in block 208 the rasterization facility returns the rasterized printing data to the entity from which the printing data was received in block 202. To return the rasterized printing data, in some cases the rasterization facility must retrieve the rasterized printing data. For example, when the GPU has been used to rasterize the printing data, the GPU may store the rasterized printing data in a staging buffer accessible to instructions executing on the CPU. In such a case, the rasterization facility may retrieve the rasterized printing data from the staging buffer so that the rasterization facility is able to use the rasterized printing data, and then may provide the rasterized printing data to the requesting entity. After the rasterized printing data is returned, the process 200 ends.

Following the process 200, the entity that requested the rasterization of the printing data may use the rasterized printing data in any suitable manner. For example, when the entity is a printer driver, the printer driver may process the rasterized printing data in any suitable manner, including by passing the rasterized printing data to other drivers in the driver stack, and following the processing the rasterized printing data may be provided to a printer for printing.

A selection of a processing unit on which to rasterize printing data may be carried out in any suitable manner according to an evaluation of any suitable criteria. FIG. 3 illustrates an exemplary process that a rasterization facility may use to select between a CPU and a GPU based on evaluating a set of criteria. In some embodiments, the process 300 of FIG. 3 that is being executed to choose between the CPU and the GPU for rasterization may be carried out by a rasterization facility executing on the CPU.

Evaluation of criteria, as in the process 300, may be carried out at any suitable time. In some embodiments, prior to evaluating criteria, a rasterization facility may receive printing data and a request to rasterize the printing data and, in response, the rasterization facility may perform the evaluation of criteria to select a processing unit on which to rasterize the printing data. In other embodiments, though, the rasterization facility may evaluate criteria before printing data is received, such as upon installation or startup of the rasterization facility or a graphics library of which the rasterization facility is a part. When the evaluation is carried out before printing data is received, a processing unit may be selected such that, when printing data is subsequently received, the processing unit on which to perform rasterization is already selected and the rasterization can be carried out without evaluating criteria or making a determination. In still other embodiments, the evaluation may be carried out before printing data is received and a result of this prior evaluation may be used by a rasterization facility alongside other evaluations of other criteria that are performed by the rasterization facility upon receipt of the printing data.

As discussed below, the exemplary process 300 includes evaluations of criteria related to the printing data and to a type of rasterization that has been requested. Accordingly, prior to the start of the process 300, a rasterization facility receives printing data and a request to rasterize the printing data and performs the process 300 to select a processing unit on which to perform the rasterization.

The process 300 begins in block 302, in which a first criterion is evaluated. The first criterion is whether a preference has been set that requests that rasterization be performed on a CPU of the computing device, rather than on the GPU. Such a preference may be set by any suitable entity. Such an entity may include a software entity, such as a service or facility, carrying out instructions to set the preference, or a human user. A human user may be a regular user, a local administrator, or a network administrator who may set preferences using policies for a network. Such a preference may be set when the entity is aware that a CPU may be a better choice for performing rasterization of printing data. In some computing devices, a GPU may be a low-resource GPU, such as one with limited processing or storage resources and/or limited processing ability. Such GPUs may provide support for various graphics operations, and therefore may be capable of performing rasterization, but may not perform rasterization quickly or efficiently as compared to other GPUs or, in some cases, a CPU. In some computing devices that include such low-resource GPUs, the computing devices may also include high-resource CPUs, such as CPUs with multiple cores that are each able to carry out operations quickly. When a computing device includes such a low-resource GPU and a high-resource CPU, the entity may be aware that performing rasterization on the CPU may be faster and more efficient than on the GPU. The entity may therefore set a preference indicating that the CPU should be used for rasterization and this preference may be evaluated in block 302.

Accordingly, if in block 302 the rasterization facility determines that a preference has been set specifying that the CPU should be used for rasterization of printing data, then in block 312 the CPU is selected for rasterization and the process 300 ends.

If, however, the rasterization facility determines that a preference specifying the CPU has not been set, then the rasterization facility continues the process 300 in block 304, in which a second criterion is evaluated. The second criterion relates to whether the GPU is compatible with the graphics library of which the rasterization facility is a part. In embodiments where a rasterization facility forms a part of a graphics library, the rasterization facility may rely on various other facilities of the graphics library to communicate with the GPU and format data for processing by the GPU. If the GPU is not compatible with the graphics library, the rasterization facility would therefore not be able to communicate properly with the GPU. Accordingly, in block 304, the rasterization facility determines whether the GPU (or a graphics card of which the GPU is a part) is compatible with the graphics library. Any suitable determination may be made to determine compatibility. In some cases, a GPU or a computing device of which the GPU is a part may store records regarding versions of a graphic library with which the GPU is compatible. Such versions may be indicated according to a particular brand of graphics library or industry standards for versions. For example, records may indicate that the GPU is compatible with graphics libraries based on the “Shader Model” industry standard, such as being compatible with “Shader Model 2.0” and higher, “Shader Model 3.0” and higher, and others. Where such an industry standard is used, the compatibility of the graphics library of the rasterization facility with the industry standard may be checked and compared to the compatibility of the GPU. The records regarding the GPU's compatibility may additionally or alternatively indicate compatibility with respect to a particular brand of graphics library, such as the DIRECTX® graphics library. In such a case, the records may indicate that the GPU is compatible with DIRECTX® 9.1 or higher, 9.3 and higher, 10.0 and higher, and others. When the graphics library of the rasterization facility is of the same brand as the brand indicated by the records regarding the GPU, the version of the graphics library may be compared to the version(s) indicated by the records to determine compatibility. Though, version numbers are not the only mechanism by which a rasterization facility could determine compatibility between the GPU and the graphics library. Any other suitable factors could be used to determine compatibility. For example, records regarding whether the GPU supports particular functionality may be checked to determine whether the GPU is compatible with the graphics library. Such functionality may the functionality of the graphics library that will be used by the rasterization facility to communicate with the GPU.

In block 304, therefore, the rasterization facility determines whether the GPU is compatible with the graphics library of the rasterization facility. If the GPU is not compatible, then in block 312 the CPU is selected for performing rasterization and the process 300 ends.

If, however, the rasterization facility determines in block 304 that the GPU is compatible with the graphics library, then in block 306 the rasterization facility determines whether the GPU supports pixel shading that will be used in performing the rasterization. Shading functionality of a GPU may support one or more of vertex shading, geometry shading, and pixel shading, with each of these shading types including multiple different functions and characteristics (e.g., grayscale shading versus high color shading). In some cases, rasterization of printing data by the GPU may make use of pixel shading. Therefore, the rasterization facility may evaluate the functionality of the GPU to determine whether the GPU supports the type of pixel shading that will be used in performing the rasterization of the printing data. Such evaluation may be carried out in any suitable manner, including by reviewing records regarding the GPU to determine a compatibility of the GPU (which may be similar to the evaluation of block 304) and/or by attempting to invoke some functionality to determine whether the pixel shader supports that functionality. If the rasterization facility determines in block 306 that the GPU does not support the type of pixel shading that will be used for the rasterization, then in block 312 the CPU is selected for performing rasterization and the process 300 ends.

If, however, the rasterization facility determines in block 306 that the GPU supports pixel shading, then in block 308 the rasterization facility determines whether the GPU supports a target color space in which the printing data is to be rasterized. When a rasterization facility receives a request to rasterize printing data, the request may include a specification of a target color space in which the printing data is to be rasterized. The rasterization facility may therefore determine whether this target color space is supported by the GPU.

Color spaces are known ways of representing color in a computer. A color space may identify colors using a combination of number values, and different color spaces may use different combinations or different types of number values. In some cases, a color space may use four number values to specify a color, such as a numbers representing amounts of the colors cyan, magenta, yellow, and black that create the color (a CMYK color space). A color space may alternatively use three number values to specify a color, such as a numbers representing amounts of the colors red, green, and blue that create the color (an RGB color space). To store the number values for a color, different types of values may be used. In some color spaces, each number of the values may be stored in binary as a string of eight bits, while in other color spaces the values may be stored as a string of 16 bits, 32 bits, 64 bits, 128 bits, or any other number of bits. As the number of bits increases, the number of combinations of values and the number of possible colors that can be created using that color space increases.

A GPU can be specially adapted to perform operations related to graphics when its hardware is arranged to support particular color spaces, such as by having its hardware arranged to support colors specified using three values or specified using four values. Additionally, the hardware of a GPU may be arranged to store those values using a certain number of bits or less. A GPU may be able to perform operations that use color spaces other than those that the GPU is specially adapted to process, but the GPU may not be able to perform operations for those other color spaces quickly or efficiently. Accordingly, in block 308 a determination may be made as to whether the GPU supports the target color space for the rasterization. Such a determination may be made by comparing the number of values used to represent color in the target color space and/or the number of bits used to store values in the target color space to the hardware arrangement of the GPU. If the number of values or bits per value of the target color space are not less than or equal to the numbers of values or bits per value of the color spaces that the hardware of the GPU is specially adapted to support, then the rasterization facility may determine that the GPU does not support the target color space.

If, in block 308, the rasterization facility determines that the GPU does not support the target color space, then in block 312 the rasterization facility selects the CPU for rasterization and the process 300 ends.

If, however, the rasterization facility determines in block 308 that the GPU supports the target color space, then in block 310 the GPU is selected for rasterization and the process 300 ends.

Following the process 300, the processing unit that the rasterization facility selects (either the GPU or the CPU) is configured by the rasterization facility to rasterize the printing data received by the rasterization facility prior to the process 300.

It should be appreciated that embodiments are not limited to carrying out the exemplary process 300 of FIG. 3. Embodiments may carry out the evaluations illustrated in FIG. 3 in a different order and may additionally or alternatively carry out any other evaluations. The outcomes of evaluations of criteria may also be different in embodiments. In the example of FIG. 3, the first criterion was whether a preference specifies use of a CPU for rasterization and, where no preference was set, the GPU would be used. In other embodiments, a facility may check for whether preference specifies a GPU and, where no preference is set, the CPU is used. In still other embodiments, the facility may check for whether any preference is set (CPU or GPU) and operate in accordance with that preference. Embodiments are not limited to reviewing any particular criteria to determine whether to perform rasterization on a CPU or a GPU. Rather, any suitable criteria may be used.

Additionally, while not illustrated in FIG. 3, one other criterion that may be evaluated in some embodiments is whether the GPU is operating properly or available. In cases where the computing device does not include a GPU, the GPU has been removed from the computing device, the GPU experiences a failure before or during rasterization, or any other condition that would make the GPU unable to perform rasterization, the rasterization facility may perform the rasterization on the CPU. In some cases, therefore, the rasterization facility may monitor for GPU errors during rasterization and, if any errors are detected, perform rasterization on the CPU.

When a GPU is used to perform rasterization, in some cases printing data to be provided to the GPU must be partitioned before being provided to the GPU. This is because some GPUs have a maximum data size that regulates how much data a GPU may process at one time, including how much data a GPU may rasterize at one time. When the printing data to be rasterized exceeds the maximum data size of the GPU, then printing data may be divided into portions and iteratively provided to the GPU for rasterization. Once each of the portions has been rasterized, the portions may be combined to form the rasterized version of the printing data.

The portions of the printing data may be identified in any suitable manner. In some cases, the portions may be identified as “tiles” of the printing data that each correspond to a portion of the page to be printed. Each tile, once rasterized, may have a resulting data size that is less than or equal to the maximum data size of the GPU.

FIG. 4 illustrates an exemplary process that may be carried out by a rasterization facility for rasterizing printing data using tiles. In some embodiments, the process 400 of FIG. 4 that is being executed to provide printing data to the GPU for rasterization may be carried out by a rasterization facility executing on the CPU.

Prior to the start of the process 400 of FIG. 4, a rasterization facility receives printing data arranged in a PDL format and selects the GPU for performing rasterization. After the GPU has been selected, the process 400 begins in block 402, in which the maximum data size for the GPU is identified, such as by reviewing records regarding the GPU.

After identifying the maximum data size, the rasterization facility begins rasterizing printing data in block 404. In particular, the rasterization facility begins a loop in block 404, in which the rasterization facility divides the printing data into portions, where each portion will result in rasterized printing data having a data size less than or equal to the maximum data size for the GPU. The portion may be identified, for example, based on the dots-per-inch (DPI) of the printer to which the rasterized printing data will be provided. For the printer to create the page from the rasterized printing data, the rasterized printing data should include a data point for each of the dots to be output by the printer. The maximum data size of the GPU may be expressed in terms of an array of points, similar to the array of pixels of a computer display screen. The array of dots for a printer is similar to the array of pixels for a display screen, in that each requires that the GPU produce values corresponding to each point in the array. To identify a portion, the array of points that is the maximum data size for the GPU (e.g., 4096×4096 points) is mapped to a desired array of dots on the page to be produced by the printer based on the DPI of the printer. The exact area of the page to which the selected portion of the printing data corresponds may be based on the DPI of the printer because the spacing of the dots of the page is based on how many dots are to be placed within one inch (i.e., the DPI). A higher DPI means the dots on the page will be closer together. When the portion of the page area that is selected for rasterization is set based on a number of dots, when the DPI is higher the selected portion of the page will be smaller.

The loop that begins in block 404 includes various operations for rasterizing printing data for a portion. In block 406, once a portion is identified in block 404, the rasterization facility identifies the locations in the page to be printed that correspond to the portion and, based on the locations, identifies from the PDL of the printing data the printing elements that at least partially overlap the identified page area for the portion. In block 408, once the printing elements have been identified, the rasterization facility creates drawing commands that describe the printing elements. The drawing commands are those commands that, when executed, produce a representation of the printing elements that overlap with the page area. These drawing commands can therefore be used to produce a rasterized version of the printing data, by producing a rasterized version of each of the printing elements of the printing data. The drawing commands can be created in any suitable manner, including according to known techniques for creating drawing commands based on data in a PDL format. For example, the functionality for creating drawing commands from a PDL that is available in the DIRECT2D™ graphics library, available from the Microsoft Corporation of Redmond, Wash., may be used to create the drawing commands. Functionality of other graphic libraries, including the DIRECTX® and DIRECTWRITE™ libraries available from the Microsoft Corporation, for creating drawing commands for content, may also be used in some embodiments.

Once the drawing commands are created, in block 410 the rasterization facility configures the GPU with a clipping area based on the page area identified in block 406 and provides the drawing commands to the GPU. Configuring the GPU with a clipping area allows the GPU to produce a rasterized version of the specific area of the page corresponding to the portion identified in block 404. Because drawing commands were created for printing elements that at least partially overlapped the page area, drawing commands are provided to the GPU that produce rasterized versions of printing data for areas outside of the page area. These drawing commands may be executed by the GPU to produce a rasterized version of a part of a printing element that lies inside the page area, but executing the drawing command in full could result in rasterized printing data for areas outside the page area. Through configuring the GPU with a clipping area, however, the GPU is aware of the page area for which a rasterized version of printing data is to be produced and can automatically discard any data that results from a drawing command and that falls outside the clipping area/page area. Thus, the GPU produces as an output a rasterized version of the printing data that corresponds only to the page area identified in block 406.

Once the GPU is provided with the clipping area and the drawing commands in block 410, the GPU may operate to produce the rasterized printing data. In block 412, therefore, the rasterization facility receives rasterized printing data from the GPU, such as by retrieving the rasterized printing data from a staging buffer associated with the GPU. The rasterized version of the printing data that corresponds to the portion identified in block 404 is then stored.

In block 414, the rasterization facility determines whether there is more page area of the printing data which has not yet been rasterized. If so, then the rasterization facility continues the process 400 in block 404, in which a next portion of the printing data is identified. The rasterization facility may therefore iteratively process portions of the printing data to rasterize the printing data. In this way, successive “tiles” of the printing data may be processed when the rasterized version of the printing data would exceed the maximum data size of the GPU.

If it is determined in block 414 that there is no more remaining page area to be rasterized, then the rasterization facility, in block 416, combines the rasterized versions of each portion to yield rasterized printing data for the complete set of printing data. Once the rasterized printing data is completed in block 416, the process 400 ends. Following the process 400, the rasterization facility may return the rasterized printing data to a requesting entity. In some embodiments, the rasterization facility may process the rasterized printing data in some way before returning the printing data to the requesting entity. For example, the rasterization facility may perform a compression process on the rasterized printing data, such as a JPEG image compression algorithm.

As should be appreciated from the discussion of FIG. 4 above, there are a number of operations that are carried out for rasterizing printing data, including creating drawing commands for a portion, rasterizing printing data using the drawing commands, and retrieving rasterized printing data from a staging buffer of the GPU to make the rasterized printing data available to processes executing on the CPU. Each of these operations may take a long time. Creating drawing commands and rasterizing printing data using the drawing commands are each resource-intensive operations that, in some environments, may take a long time to fully execute. Retrieving the rasterized printing data from the staging buffer may also take a long time because, in many computer systems, the staging buffer is a relatively slow memory and retrieving data from the staging buffer therefore requires a long time to complete. Additionally, making data that is stored in the staging buffer available to the CPU for operations is a multi-step process. The data must be retrieved from the staging buffer and placed in system main memory and then subsequently moved from system main memory to the CPU cache for operations. These steps each add more time to the process.

Because these operations take a relatively long time to complete, if these operations were each performed in series, one after the other, the rasterization process would, as a whole, take a relatively long time to complete. Various advantages could be realized, therefore, by performing at least some of these operations in parallel.

In some embodiments, a rasterization facility executing on a CPU may be configured to carry out some operations of a rasterization process on the CPU while the GPU rasterizes printing data to create rasterized printing data. FIG. 5 illustrates an exemplary process that may be carried out to operate a CPU and GPU concurrently during a rasterization process. The steps and outputs of the process 500 of FIG. 5 are similar to those of process 400 of FIG. 4, and FIG. 5 will therefore be described with reference to FIG. 4.

Prior to the start of the process 500 of FIG. 5, a rasterization facility receives printing data arranged in a PDL format and selects the GPU for performing rasterization. After selecting the GPU for rasterization, the process 500 begins in block 502, in which the rasterization facility executing on the CPU operates the CPU to create drawing commands corresponding to a first portion of the printing data arranged in the PDL format. Creating drawing commands corresponding to a first portion may include identifying the portion, the page area, and the printing elements for the portion and then creating the drawing commands, as discussed above in connection with FIG. 4. The operations of the CPU in block 502 may be similar to the operations of blocks 404, 406, and 408 in FIG. 4.

Once the drawing commands are created by the rasterization facility executing on the CPU in block 502, then in block 504 the GPU is configured with the drawing commands for the portion to be rasterized. The operations of block 504 may be carried out in any suitable manner, including according to the operations discussed above in connection with block 410 of FIG. 4.

After the GPU is configured in block 504 and begins rasterizing printing data based on the drawing commands, in block 506 the rasterization facility determines whether more printing data exists in the page that has not yet been portioned and for which drawing commands have not yet been created. If the rasterization facility determines that more printing data exists, then the process 500 continues to block 508.

In block 508, while the GPU is rasterizing printing data using the drawing commands with which the GPU was configured in block 504, the rasterization facility operates the CPU to create drawing commands for one or more next portions of the printing data. The portion(s) may be identified and drawing commands created as in block 502 above. If no more printing data remains, however, then the process 500 continues in block 510.

By operating the CPU and GPU in parallel to create the drawing commands for the next portion(s) on the CPU while the GPU is rasterizing previously-identified portions, the rasterization process may be expedited as compared to performing operations in series. Further speed benefits may be realized by also performing a retrieval of rasterized printing data for one portion from the staging buffer of the GPU while the GPU is rasterizing a next portion.

Accordingly, in block 510, when the rasterization facility executing on the CPU detects that the GPU has finished rasterizing the portion with which the GPU was configured in block 504, the rasterization facility begins retrieving the rasterized printing data for the portion. The rasterization facility may detect that the GPU has finished rasterizing the portion in any suitable manner, including by detecting when the GPU sets a flag indicating that the GPU has finished the rasterization operation. Regardless of the manner of detection, once the rasterization facility detects the completion, the rasterization facility may begin retrieving the rasterized printing data for the portion by requesting that the rasterized printing data be transferred from the GPU staging buffer to a storage directly accessible by the CPU, such as system main memory.

After the rasterization facility begins retrieving the rasterized printing data, the rasterization facility determines in block 512 whether any more portions for which drawing commands were created remain to be rasterized. If so, then the rasterization facility continues the process 500 in block 504, in which the drawing commands for a next portion are used to configure the GPU as discussed above and, in block 508, operate the CPU concurrently to create drawing commands for printing data if any printing data remains.

If, however, in block 512 the rasterization facility determines that no more portions remain to be rasterized, the process 500 ends.

Through the process 500, the rasterization facility can operate the CPU and GPU concurrently to carry out a rasterization process and gain some advantages in speed through performing operations in parallel. To aid in understanding how the operations can be performed in parallel, FIG. 6 shows a timing sequence of operations that can be carried out by a CPU and a GPU as part of an exemplary rasterization process. The operations shown in FIG. 6 are equivalent to the operations discussed above in connection with FIGS. 4 and 5. Therefore, the operations of FIG. 6 will not be discussed in detail.

The operations illustrated in FIG. 6 include those that can be carried out by a rasterization facility executing on a CPU as well as those operations carried out by a GPU that has been configured by the rasterization facility. The timing sequence shows how these operations are performed in parallel. In the illustration of FIG. 6, time flows from the top of the page to the bottom, with operations shown at similar vertical positions in the page being performed at similar times.

In the example of FIG. 6, the rasterization facility operates two execution threads that permit the rasterization facility to carry out two sets of operations in parallel. The two threads are illustrated in FIG. 6 as two different vertical sequences of operations, grouped as “Thread 1” and “Thread 2.” Thread 1 is shown responsible for the creation of drawing commands and provision of drawing commands to the GPU, while Thread 2 is shown responsible for retrieving rasterizing printing data from the staging buffer of the GPU.

As in the example of FIG. 5, the first operation shown in the example of FIG. 6 is the operation 602 in Thread 1 of the rasterization facility to create first drawing commands for a first portion of the printing data. Once the first drawing commands are created, then Thread 1 of the rasterization facility carries out operation 604 of providing the first drawing commands to the GPU.

Once the drawing commands are provided to the GPU by Thread 1, then in operation 608 Thread 2 of the rasterization facility begins watching for the completion signal from the GPU to indicate completion of the rasterization. Additionally, the GPU begins rasterizing printing data using the first drawing commands for the first portion.

While Thread 2 is waiting for the completion signal and the GPU is performing the rasterization, Thread 1 of the rasterization facility executing on the CPU is operating in parallel to carry out operation 610 to create second drawing commands for a second portion of the printing data.

After time passes, the GPU signals completion of rasterization in operation 612. In response, Thread 2 begins retrieving the rasterized version of the first portion of the printing data in operation 614. While Thread 2 is retrieving the rasterized version of the first portion, Thread 1 provides the second drawing commands to the GPU in operation 616.

The sequence of operation is then repeated for the second portion of the printing data and a third portion, with Thread 1, Thread 2, and the GPU operating substantially in parallel to carry out the rasterization process. In operation 618, the GPU begins rasterizing using the second drawing commands, in operation 620 Thread 2 watches for the completion signal from the GPU, and in operation 622 Thread 1 creates third drawing commands for a third portion of the printing data. Once the GPU signals completion of rasterization in operation 624, Thread 2 begins retrieving the rasterized version of the second portion in operation 626 and, in operation 628, Thread 1 provides the third drawing commands to the GPU. Once the third drawing commands are provided to the GPU by Thread 1, in operation 630 the GPU rasterizes the third portion using the third drawing commands.

The types of operations illustrated in FIG. 6 would continue in parallel until all of the printing data had been divided into portions and rasterized by the GPU. Following rasterization of the portions, the rasterized versions for each of the portions would be combined and returned to a requesting entity as rasterized printing data, as discussed above in connection with block 416 of FIG. 4.

As discussed in the examples above, a rasterization facility may carry out various operations as part of a rasterization process. The rasterization facility may determine whether to perform rasterization on a CPU or a GPU, as discussed in connection with FIG. 3, may divide printing data into multiple portions for rasterization, as discussed in connection with FIG. 4, and may concurrently operate a CPU and GPU to perform the rasterization process, as discussed in connection with FIGS. 5 and 6.

In some embodiments, a rasterization facility may carry out operations related to a target color space in which the printing data is to be rasterized and printed. As discussed above in connection with FIG. 3, various color spaces exist that are different ways of representing colors using number values. In some cases, a request to rasterize printing data may be accompanied by a specification of the target color space in which the entity requesting rasterization wants the printing data to be rasterized and printed. The target color space may be specified in this way because, in some cases, the printing elements identified and described by the PDL of the printing data may not all be in the target color space. The rasterization facility, by receiving the target color space, may review the printing elements and ensure that all printing elements are in the target color space before rasterizing the printing data.

FIG. 7 illustrates an exemplary process for converting printing elements to a target color space. The process 700 of FIG. 7 can be executed by a rasterization facility executing on a CPU. The process 700 begins in block 702, in which the rasterization facility receives a request to rasterize printing data in a target color space. The target color space may be identified in the request in any suitable manner, including using known identifiers for color spaces. The request received in block 702 may also include printing data arranged in PDL format that identifies and describes at least one printing element included in the page to be printed.

In block 704, the rasterization facility reviews the original color space of each printing element identified by the PDL to determine whether the original color space of the printing element matches the target color space. This determination may be made in any suitable manner, including by reviewing the format of stored data regarding the printing element, reviewing metadata regarding the printing element, or performing any suitable analysis on the printing element to determine the original color space, and then comparing the original color space to the target color space specified in block 702.

In block 704, the rasterization facility converts all printing elements that are not in the target color space to the target color space. The conversion of block 706 may be carried out in any suitable manner, including using known techniques. For example, the conversion may be carried out using conversion functionality available through the WINDOWS® Imaging Component available from the Microsoft Corporation of Redmond, Wash.

In block 708, once the printing elements are all in the target color space, a rasterization process may be carried out on the printing data using any suitable technique, including the rasterization techniques described herein. Once the printing data has been rasterized, the process 700 ends.

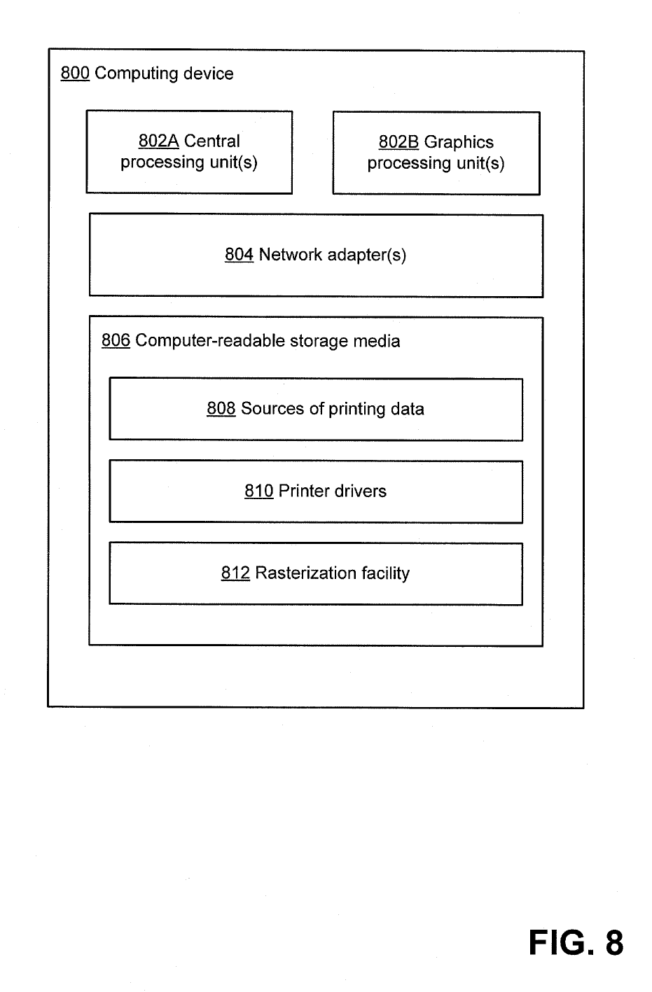

FIG. 8 illustrates an exemplary implementation of a computing device in the form of a computing device 800 that may be used in a system implementing the techniques described herein, although others are possible. It should be appreciated that FIG. 8 is intended neither to be a depiction of necessary components for a computing device to operate in accordance with the principles described herein, nor a comprehensive depiction.

Computing device 800 may comprise central processing unit(s) 802A and graphics processing unit(s) 802B (collectively referred to below as processor(s) 802), a network adapter 804, and computer-readable storage media 806. Computing device 800 may be, for example, a desktop or laptop personal computer, a personal digital assistant (PDA), a tablet computer, a server, a print server or other networking element, or any other suitable computing device. Network adapter 804 may be any suitable hardware and/or software to enable the computing device 800 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 806 may be adapted to store data to be processed and/or instructions for execution by processor(s) 802. Processor(s) 802 enables processing of data and execution of instructions. The data and instructions may be stored on the computer-readable storage media 806 and may, for example, enable communication between components of the computing device 800.

The data and instructions stored on computer-readable storage media 806 may comprise computer-executable instructions implementing techniques which operate according to the principles described herein. In the example of FIG. 8, computer-readable storage media 806 stores computer-executable instructions implementing various facilities and storing various information as described above. Computer-readable storage media 806 may store computer-executable instructions for one or more sources of printing data 808, one or more printer drivers 810, and a rasterization facility 812 employing any of the techniques described herein.

While not illustrated in FIG. 8, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. An apparatus comprising:
a graphics processing unit (GPU);
a central processing unit (CPU); and
at least one computer-readable storage medium having encoded thereon processor-executable instructions that, when executed by the CPU, cause the CPU to act as:
a graphics library to rasterize printing data arranged in a page description language (PDL) format to yield rasterized printing data, the graphics library being adapted to rasterize the printing data at least in part by determining whether to invoke the GPU to perform the rasterization, and
a printer driver to prepare the printing data for printing by a printer at least in part by requesting that the graphics library rasterize the printing data.

2. The apparatus of claim 1, wherein the graphics library is adapted to determine whether to invoke the CPU or the GPU to perform the rasterization.

3. The apparatus of claim 1, wherein the graphics library is adapted to determine whether to invoke the GPU to perform the rasterization based at least on capabilities of the GPU.

4. The apparatus of claim 3, wherein:
the printer driver is adapted to receive the printing data with a specification of a color space in which the printing data is to be printed; and
the graphics library is adapted to receive the specification of the color space from the driver and to determine whether to invoke the GPU based at least in part on whether the GPU is able to process printing data in the color space.

5. The apparatus of claim 3, wherein the graphics library is adapted to determine whether the invoke the GPU based at least in part on whether the GPU provides pixel shading functionality.

6. The apparatus of claim 1, wherein the graphics library is adapted to determine whether to invoke the GPU to perform the rasterization at least in part by evaluating hardware capabilities of the CPU and of the GPU to determine whether rasterizing operations would be performed faster on the CPU or the GPU.

7. The apparatus of claim 1, wherein the graphics library is adapted to determine how to whether to invoke the GPU to perform the rasterization based at least in part on whether a user has configured the graphics library to use the CPU or the GPU for the rasterizing.

8. The apparatus of claim 1, wherein the graphics library is adapted to rasterize the printing data at least in part by, when the GPU is to be used to perform the rasterizing:
determining a maximum data size of the GPU, and
when the printing data exceeds the maximum data size, dividing the printing data into a plurality of portions, each of the plurality of portions having a size less than or equal to the maximum data size, and iteratively operating the GPU to rasterize each of the plurality of portions.

9. The apparatus of claim 8, wherein the graphics library is further adapted to rasterize the printing data at least in part by, when the GPU is to be used to perform the rasterizing:
while the GPU is rasterizing a first portion of the printing data, identifying a next portion of the printing data and creating drawing commands for rasterizing the next portion;
when the GPU has finished rasterizing the first portion, obtaining a rasterized version of the first portion from memory associated with the GPU; and
when the GPU has finished rasterizing the first portion, configuring the GPU to rasterize the next portion.

10. A method of rasterizing printing data using a central processing unit (CPU) and a graphics processing unit (GPU), the printing data being arranged in a page description language (PDL), wherein the rasterizing is done using a plurality of portions of the printing data, each of the plurality of portions corresponding to a rasterized version having a size less than or equal to a maximum data size of the GPU, the method comprising:
with the GPU, rasterizing a first portion of the printing data;
with the CPU, while the GPU is rasterizing the first portion, identifying a next portion of remaining printing data that has not yet been rasterized and making the next portion available to the GPU;
with the CPU, when the GPU has finished rasterizing the first portion, obtaining a rasterized version of the first portion; and
with the CPU, when the GPU has finished rasterizing the first portion, configuring the GPU to rasterize the next portion.

11. The method of claim 10, further comprising:
repeating the rasterizing, identifying, obtaining, and configuring until all of the printing data has been rasterized.

12. The method of claim 10, further comprising:
with the CPU, combining the rasterized version of each portion of the printing data to form rasterized printing data.

13. The method of claim 10, wherein identifying the next portion of the remaining printing data comprises, with the CPU:
identifying a page area to be rasterized, the page area being less than the maximum data size;
evaluating the printing data arranged in the PDL to determine at least one printing element of the printing data that falls within the page area; and
creating drawing commands representing the at least one printing element.

14. The method of claim 13, wherein configuring the GPU to rasterize the next portion comprises configuring the GPU with the page area to be rasterized and providing the drawing commands to the GPU.

15. The method of claim 13, wherein evaluating the printing data arranged in the PDL to determine the at least one printing element comprises determining each printing element of the printing data that at least partially overlaps the page area to be rasterized.

16. At least one computer-readable storage medium encoded with computer-executable instructions that, when executed by a computer, cause the computer to carry out a method of rasterizing printing data, the printing data being arranged in a page description language (PDL), the method comprising:
receiving a specification of a target color space with which the printing data is to be printed;
determining an original color space of each of the printing elements of the printing data;
for each printing element having an original color space that does not match the target color space, converting the printing element to the target color space; and
following the converting, rasterizing the printing data.

17. The at least one computer-readable storage medium of claim 16, wherein converting the printing element to the target color space comprises converting a printing element from an original color space having a first number of bits per component to the target color space having a second number of bits per component different from the first number of bits per component.

18. The at least one computer-readable storage medium of claim 16, wherein converting the printing element to the target color space comprises converting each binary image of the printing data to the target color space.

20. The at least one computer-readable storage medium of claim 16, wherein the computer-executable instructions are arranged in the form of a library having at least one interface for communicating with a printer driver regarding rasterization of the printing data.
